(19) United States
(12) Patent Application Publication
(10) Pub. No.: US 2015/0072148 A1
(43) Pub. Date: Mar. 12, 2015

(54) CONDUCTIVE RESIN BELT, METHOD OF MANUFACTURING THE CONDUCTIVE RESIN BELT, AND IMAGE FORMING APPARATUS EMPLOYING THE CONDUCTIVE RESIN BELT

(71) Applicants: Yumiko Hayashi, Kanagawa (JP); Sumio Kamoi, Tokyo (JP); Takashi Tanaka, Kanagawa (JP)

(72) Inventors: Yumiko Hayashi, Kanagawa (JP); Sumio Kamoi, Tokyo (JP); Takashi Tanaka, Kanagawa (JP)

(73) Assignee: RICOH COMPANY, LTD., Tokyo (JP)

(21) Appl. No.: 14/449,359

(22) Filed: Aug. 1, 2014

(30) Foreign Application Priority Data
Sep. 11, 2013 (JP) 2013-188578

(51) Int. Cl. B32B 9/04; G03G 15/01

(52) U.S. Cl. CPC G03G 15/1605; G03G 5/071; G03G 5/075
USPC 428/411.1; 399/302

(57) ABSTRACT

A conductive resin belt includes at least one amorphous polymer selected from a first group consisting of polyether imide and polyether sulfone, at least one crystalline polymer selected from a second group consisting of polyether ether ketone and polyphenylene sulfide, at least one reactive polymer selected from a third group consisting of a copolymer of ethylene and glycidyl methacrylate and a polymer including an oxazoline group, and a conductivity imparting material. Surface resistivity of the conductive resin belt at 500V is 10⁶ Ω/sq. Volume resistivity of the conductive resin belt at 100V is 10⁶ Ω·cm to 10¹⁴ Ω·cm. A cross-section of the conductive resin belt includes a dispersion phase and a continuous phase. The reactive polymer exists at a concentration of 30% to 70% within 10 nm to 1 μm of an interface between the dispersion phase and the continuous phase.

### CROSS-REFERENCE TO RELATED APPLICATIONS

This patent application is based on and claims priority pursuant to 35 U.S.C. §119 from Japanese Patent Application No. 2013-188578, filed on Sep. 11, 2013 in the Japan Patent Office, which is hereby incorporated by reference herein in its entirety.

### BACKGROUND

1. Technical Field

Exemplary embodiments of the present disclosure generally relate to a conductive resin belt, a method of manufacturing the conductive resin belt, and an image forming apparatus employing the conductive resin belt.

2. Description of the Related Art

An intermediate transfer belt employed for an electrophotographic device requires uniformity in electrical resistance; surface smoothness; mechanical properties such as high flexibility, high elasticity, and high elongation; and high dimensional precision such as in film thickness or circumferential length. Recently, flame retardant properties are also desired at a part level and achieving a rating of VTM-0 under the UL94 standard has become a requirement. Employed materials that satisfy the above-described required properties are a thermosetting polyimide resin and a polyamide imide resin including a material imparting conductivity.

The intermediate transfer belt is a high-cost part in the electrophotographic device and there is a strong demand for cost reduction. If a thermoplastic resin is employed and molding with an extrusion molding method or an inflation molding method is possible, the intermediate transfer belt may be manufactured at an extremely low cost and cost reduction may be obtained. Examples of the thermoplastic resins in actual use include a fluorine-based resin such as polyvinylidene chloride (hereinafter referred to as PVDF), a polyarylate resin, a polyphenylene sulfide (hereinafter referred to as PPS) resin, a polyether sulfone (hereinafter referred to as PES) resin, a polysulfone (hereinafter referred to as PS) resin, a polyether inside (hereinafter referred to as PEI) resin, a polyether ether ketone (hereinafter referred to as PEEK) resin, a thermoplastic polyimide (hereinafter referred to as TPI), and a liquid crystal polymer (hereinafter referred to as LCP).

### SUMMARY

In view of the foregoing, in an aspect of this disclosure, there is provided a novel conductive resin belt including at least one amorphous polymer selected from a first group consisting of polyether imide and polyether sulfone, at least one crystalline polymer selected from a second group consisting of polyether ether ketone and polyphenylene sulfide, at least one reactive polymer selected from a third group consisting of a copolymer of ethylene and glycidyl methacrylate and a polymer including an oxazoline group, and a conductivity imparting material. Surface resistivity of the conductive resin belt at 500V is 10⁶ Ω/sq to 10¹⁴ Ω/sq. Volume resistivity of the conductive resin belt at 100V is 10⁶ Ω·cm to 10¹⁴ Ω·cm. A cross-section of the conductive resin belt includes a dispersion phase and a continuous phase. The reactive polymer exists at a concentration of 30% to 70% within 10 nm to 1 μm of an interface between the dispersion phase and the continuous phase, with the conductivity imparting material eccentrically located at either the dispersion phase or the continuous phase.

The aforementioned and other aspects, features, and advantages will be more fully apparent from the following detailed description of illustrative embodiments, the accompanying drawings, and associated claims.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view of an example of a configuration of a full-color image forming apparatus employing an intermediate transfer method;

FIG. 2 is a graph showing change of melt viscosity when PEEK is blended to PES;

FIG. 3 is a graph showing a relation of elongation and a blending amount of PPS with respect to a total of PES and PPS;

FIG. 4 is a graph showing a relation of a MIT value and a blending amount of PPS with respect to a total of PES and PPS;

FIG. 5 is a TEM photograph of a cross-section of a conductive resin belt according to an embodiment of the present invention; and

FIG. 6 is a schematic view of an example of a mandrel directly connected to a die provided at a downstream direction of extrusion of the die in a process that obtains a molded product by extrusion molding a melt-kneaded product in a method of manufacturing a conductive resin belt according to an embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

Hereinafter, exemplary embodiments of the present invention are described in detail with reference to the drawings. However, the present invention is not limited to the exemplary embodiments described below, but may be modified and improved within the scope of the present disclosure.

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

There is provided a novel conductive resin belt, which may be made at low cost and which satisfies the following mechanical, electrical, and flame retardant requirements according to an embodiment of the present invention:

1. Mechanical Properties
(1) Tensile strength (rupture point stress)/in compliance with JIS-K7127, 50 MPa or more
(2) Tensile elasticity/in compliance with JIS-K7127, 1800 MPa or more
(3) Elongation at rupture point/in compliance with JIS-K7127, 20% or more
(4) Flexibility resistance (Mechanical integrity test, hereinafter referred to as MIT)/in compliance with JIS-P8115, 500 times or more (Film thickness 70±10 μm)
(5) Tear strength/in compliance with JIS-K7128, 3 N/mm or more

2. Electrical Properties
(1) Surface resistivity: 10⁶ Ohms per Square (Ω/sq) to 10¹⁴ Ω/sq, preferably 10⁸ Ω/sq to 10¹¹ Ω/sq
   (Between 10V to 500V)
(2) Volume resistivity: 10⁶ Ohm centimeter (Ω·cm) to 10^{‥}Ω·cm, preferably 10⁸ Ω·cm to 10¹¹ Ω·cm
   (Between 10V to 500V)

3. Flame Retardant Properties: UL94 Standard VTM-0

The conductive resin belt according to an embodiment of the present invention is formed of at least one amorphous polymer selected from a first group described below, at least one crystalline polymer selected from a second group described below, at least one reactive polymer selected from a third group described below, and a conductivity imparting material. Surface resistivity at 500V is 10⁶ Ω/sq to 11¹⁴ Ω/sq. Volume resistivity at 100V is 10⁶ Ω·cm to 10¹⁴ Ω·cm. A cross-section of the conductive resin belt includes a dispersion phase and a continuous phase. The reactive polymer exists at a concentration of 30% to 70% within 10 nm to 1 μm of an interface between the dispersion phase and the continuous phase. The conductivity imparting material is eccentrically located at either the dispersion phase or the continuous phase.
(First group) Polyether imide or polyether sulfone
(Second group) Polyether ether ketone or polyphenylene sulfide
(Third group) A copolymer of ethylene and glycidyl methacrylate or a polymer including an oxazoline group

Surface resistivity in a range of from 10⁶ Ω/sq to 10¹⁴ Ω/sq at 500V and volume resistivity in a range of from 10⁶ Ω·cm to 10¹⁴Ω·cm at 100V are electrical properties desired for an intermediate transfer belt or a transfer belt according to an embodiment of the present invention.

Surface resistivity and volume resistivity may be measured as follows:
Sample humidity control conditions: 20±3° C., Relative humidity: 50±10%, humidity control for four hours
Measurement environment: 20±3° C., Relative humidity: 50±10%
Measurement device: Hiresta UP Model MCP-HT450 (from DIA Instruments Co., Ltd.)
Measurement voltage: 10V, 100V, 250V, 500V
Voltage application time: 10 sec value

The cross-section of the structure of the conductive resin belt according to an embodiment of the present invention includes the dispersion phase and the continuous phase, with the reactive polymer present at the concentration of 30% to 70% within 10 nm to 1 μm of the interface between the dispersion phase and the continuous phase.

Concentration of existence of the reactive polymer as a percentage may be obtained by analysis of a transmission electron microscopy (TEM) image. However, there are cases in which the reactive polymer present near the interface may not be confirmed with a TEM image due to a layer being too thin. Accordingly, in the present embodiment, the reactive polymer present near the interface is calculated from a blending ratio of each resin and a phase-separated structure of a TEM image. Islands of the reactive polymer observed with the TEM image are the non-reacted reactive polymer left in the interface between the dispersion phase and the continuous phase, and is understood as present in the interface. The concentration of the reactive polymer present within 10 nm to 1 μm of the interface is obtained as follows.

(Concentration of a reactive polymer present within a range of 10 nm to 1 μm of an interface)=(Blending ratio of the reactive polymer with respect to a mixed and kneaded whole)−(Area ratio of islands of the reactive polymer in a TEM image)

By eccentrically locating the conductivity imparting material being at either the continuous phase and the dispersion phase, a desired resistance value is obtained with a small blending value of the conductivity imparting material and decline in mechanical strength due to blending the conductivity imparting material may be reduced compared to a case of blending the conductivity imparting material to a single material. Not only an effect due to the above-described reduction of the blending ratio of the conductivity imparting material is obtained but also an effect of maintaining strength of a polymer phase having no eccentrically located conductivity imparting material may be obtained.

It is preferable that the conductivity imparting material is eccentrically located at the continuous phase. With regards to a comparison having the same blending ratio of the conductivity imparting material, voltage dependence is easier to control when the conductivity imparting material is eccentrically located at the continuous phase compared to when the conductivity imparting material is eccentrically located at the dispersion phase (i.e., islands). When the conductivity imparting material is eccentrically located at the dispersion phase, controlling distance between dispersion phases (i.e., distance between islands) is difficult and controlling voltage dependence is difficult.

A diameter of the dispersion phase (i.e., island) may be controlled by changing a blending ratio of the reactive polymer. By controlling the diameter of the dispersion phase, sensitivity of resistance value and voltage dependence with respect to blending quantity of the conductivity imparting material may be controlled.

Further, due to an effect of making an alloyed polymer from a mix of a plurality of polymers of the first, the second group, and the third group, mechanical properties (Elongation, MIT value, etc.) of a film are enhanced.

In other words, electrical properties of the above-described conductive resin belt may be controlled. Accordingly, high precision and stable high surface resistivity and volume resistivity are consistently obtained.

In a polymer alloy, in general, a larger quantity resin in a blend becomes the continuous phase and a smaller quantity resin in the blend becomes the dispersion phase.

When the conductivity imparting material is blended to the above-described polymer alloy, the conductivity imparting material becomes eccentrically located at one of the resins. Eccentric-location of the conductivity imparting material does not depend on a blending ratio but is determined by the material:

1. In a case of polyether imide (hereinafter referred to as PEI) and polyphenylene sulfide (hereinafter referred to as PPS), the conductivity imparting material is eccentrically located at PEI when PEI is either a continuous phase or a dispersion phase.

2. In a case of PEI and polyether ether ketone (hereinafter referred to as PEEK), the conductivity imparting material is eccentrically located at PEI when PEI is either a continuous phase or a dispersion phase.

3. In a case of polyether sulfone (hereinafter referred to as PES) and PPS, the conductivity imparting material is eccentrically located at PES when PES is either a continuous phase or a dispersion phase.

4. In a case of PES and PEEK, the conductivity imparting material is eccentrically located at PES when PES is either a continuous phase or a dispersion phase.

It is to be noted that the conductivity imparting material eccentrically located at the continuous phase or the dispersion phase is defined as concentration of existence of the conductivity imparting material is approximately 90% or more at either the continuous phase or the dispersion phase.

Eccentric-location of the conductivity imparting material is determined by the material. Accordingly, to eccentrically locate the conductivity imparting material at the continuous phase, it is preferable to make a larger blending quantity of a polymer at which the above-described conductivity imparting material is eccentrically located.

In general, PEI is known as a flame retardant material, known to be amorphous, and known to have the structure shown below. In an embodiment of the present invention, there is no restriction regarding PEI as long as PEI has the structure shown in chemical 1 and is amorphous, and PEI may be a modified product with other materials.

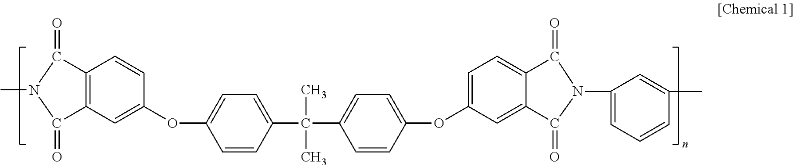

PEI may be commercially available products. For example, Ultem 1000 (from SABIC Innovative Plastics Japan).

Polyether imide is known as a flame retardant material. However, as shown in table 1, in a film in which carbon black (hereinafter referred to as CB) is blended to PEI, mechanical properties of elongation at rupture point and flexibility resistance of the film are insufficient. In a case in which polymers of PPS and PEEK of the above-described second group are employed to make alloyed polymers, a target value of a property of each of the alloyed polymers is not attained as shown in Table 1. Thus, in an embodiment of the present invention, it is determined that in an alloyed polymer blended with the reactive polymer target properties may be achieved by a synergistic effect of making an alloy even between materials having the same insufficient property.

TABLE 1

| | | CB Compound (Ketjen black 5.0% blended) | | | |
|---|---|---|---|---|---|
| | Target value | PEI | PES | PPS | PEEK |
| Tensile | 50 MPa or | Good | Good | Good | Good |
| strength | more | | | | |
| Elongation at | 20% or more | Poor | Poor | Poor | Poor |
| rupture point | | | | | |
| Flexibility | 500 times or | Poor | Poor | Good | Good |
| resistance | more | | | | |
| Tear strength | 3 N/mm or | Good | Good | Good | Good |
| | more | | | | |
| Tensile | 1800 MPa or | Good | Good | Good | Good |
| elasticity | more | | | | |
| Flame | VTM-0 | Fair (Note 1) | Good | Good | Good |
| retardant | | | | | |
| properties | | | | | |

Good: Target value attained
Poor: Target value not attained
Fair (Note 1): Dependent on film thickness.
VTM-1 (However, epoxy-based compatibilizer 2% blended) with thin film of 50 μm

In general, PES is known as a flame retardant material, known to be amorphous, and known to have a structure shown below. In an embodiment of the present invention, there is no restriction regarding PES as long as PES has the structure shown and is amorphous, and PES may be a modified product with other materials.

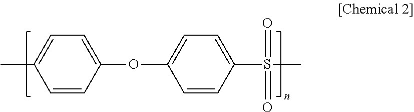

PES may be commercially available products. For example, 4100G (from Sumitomo Chemical Co, Ltd.) and E3010 Natural (from BASF Japan Ltd.).

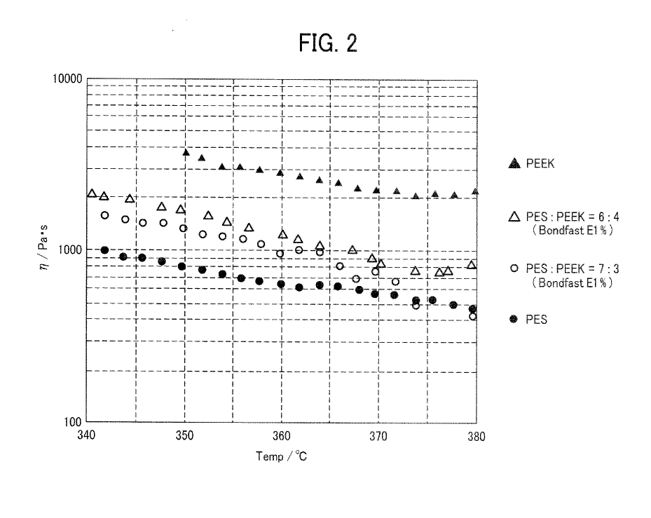

Change of melt viscosity when PEEK is blended to PES is shown in FIG. 2. Melt viscosity of a polymer alloy of PES and PEEK show that additivity approximately holds, and indicates that formability may be controlled by a blending ratio. Control of melt viscosity by a blending ratio is not limited to the polymer alloy of PES and PEEK. Control of melt viscosity by the blending ratio is confirmed to hold in other polymer combinations.

In an embodiment of the present invention, PPS is a crystalline heat-resistant polymer having a structure shown below. PPS may be broadly divided into two types, a cross-linked type polymer and a linear polymer. In a case of manufacturing a thin film as in an embodiment of the present invention, PPS is preferably the linear polymer. In the cross-linked type polymer, many gelling products are included and may appear as flaws on a surface when a film is formed and is unfavorable.

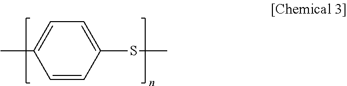

PPS may be commercially available products. Specific examples of the linear polymer include PY-23 (from Toray Industries, Inc.) and P-4 (from Chevron Phillips Chemical Company).

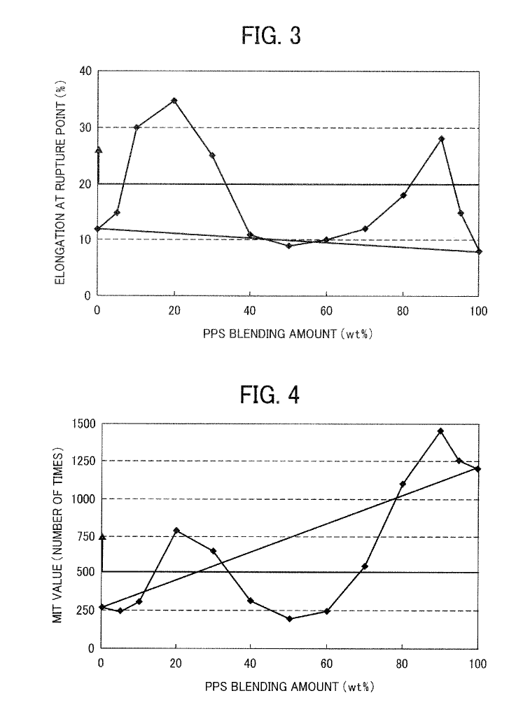

When PPS is alloyed, PPS takes on a micro phase-separated structure, and a region in which elongation and a MIT value are significantly enhanced is generated due to a blending amount of PPS. A relation of elongation and a blending amount of PPS with respect to a total of PES and PPS is shown in FIG. 3. When the blending amount of PPS is 5% by mass to 40% by mass and in a range of from 70% by mass to 95% by by mass, position becomes positive according to the rule of additivity, and it is understood that a synergistic effect is exhibited.

A relation of a MIT value and a blending amount of PPS with respect to a total of PES and PPS is shown in FIG. 4. When the blending amount of PPS is 10% by mass to 40% by mass and in a range of from 60% by mass to 95% by mass, position becomes positive according to the rule of additivity. Accordingly, it is understood that the MIT value exhibits a synergistic effect.

With consideration to PPS preferably being the dispersion phase in an embodiment of the present invention, when employing PPS, it is particularly preferable that the blending amount of PPS with respect to a total of PPS and an amorphous polymer selected from the first group is 10% by mass to 40% by mass.

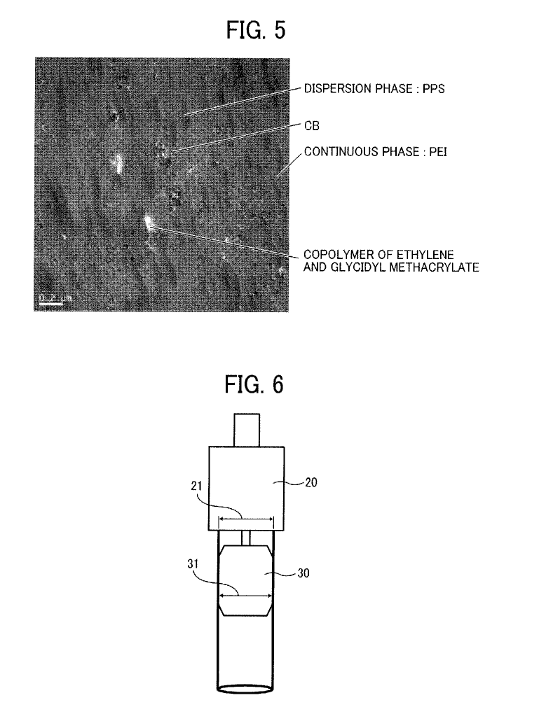

FIG. 5 is a TEM photograph of a cross-section of the conductive resin belt according to an embodiment of the present invention. The conductivity imparting material of CB is eccentrically located at a continuous phase of PEI, and almost no CB exists at a dispersion phase of PPS. By CB being eccentrically located at the continuous phase, low resistance is obtained with a small CB blending ratio and decline in mechanical strength due to blending of CB may be reduced. White areas are a copolymer of ethylene and glycidyl methacrylate of a reactive polymer.

By blending PPS, it is understood that properties of elongation and a MIT value that are particularly important in a conductive belt for electrophotography are significantly enhanced. Accordingly, an embodiment of the present invention is obtained.

In an embodiment of the present invention, PEEK has a structure shown below and is a crystalline heat-resistant polymer. However, there is no restriction regarding PEEK and PEEK may be a modified product with other materials.

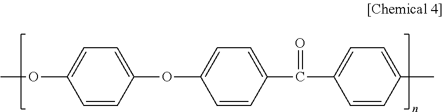

PEEK may be commercially available products. For example, 5000G (from Daicel-Evonik Ltd.) and 450P (from Victrex Japan).

In an alloyed polymer with PEEK, flexibility resistance (i.e., number of times of MIT) is significantly enhanced similar to PPS. In addition, due to tensile strength and tensile elasticity of PEEK by itself being high, tensile strength and tensile elasticity of the alloyed product is also high. Preferably, a blending amount of PEEK is 10% by mass to 40% by mass similar to PPS. However, compared to other materials, PEEK is an extremely expensive material and thus the blending amount of PEEK is preferably kept to 30% by mass or less.

Most combinations of different type of polymers are partially compatible or non-compatible. However, combinations that exhibit a synergistic effect by being alloyed depart from the rule of additivity and are often partially compatible or non-compatible combinations. Non-compatible combinations of polymers have low affinity. Accordingly, a dispersion phase becomes coarse due to not mixing well and mechanical properties decline due to weak adhesion at the interface between the dispersion phase and a continuous phase. Thus, how to control a phase-separated structure of a non-compatible combination is extremely important in development of a polymer alloy. Functions of a reactive polymer include increasing affinity between different polymers, refinement of the dispersion phase, stabilization of the phase-separated structure, and enhancement of adhesion at interface between a dispersion phase and a continuous phase. The reactive polymer is susceptible to thermal deterioration at a temperature region of forming a super engineering plastic. Thus, when a blending amount of the reactive polymer is excessive, flaws may appear when forming a film. Accordingly, the blending amount of the reactive polymer is 5% by mass or less with respect to a total of resins. More preferably, the blending amount of the reactive polymer is kept to 2% by mass or less with respect to the total of resins. A preferable lower limit for the blending amount of the reactive polymer is 1% by mass.

In an embodiment of the present invention, a copolymer of ethylene and glycidyl methacrylate is the copolymer of ethylene and a structure shown below. However, there is no restriction regarding the copolymer of ethylene and glycidyl methacrylate, and the copolymer of ethylene and glycidyl methacrylate may be a modified product with other materials.

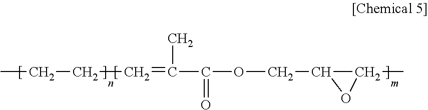

The copolymer of ethylene and glycidyl methacrylate may be commercially available products. For example, Bondfast E (from Sumitomo Chemical Co, Ltd.).

In an embodiment of the present invention, a polymer including an oxazoline group is an amorphous polymer having a structure shown below. However, there is no restriction regarding the polymer including the oxazoline group and the polymer including the oxazoline group may be a modified product with other materials.

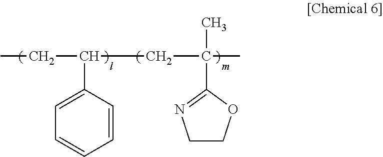

The polymer including the oxazoline group may be commercially available products. For example, Epocros RPS-1005 (from Nippon Shokubai Co., Ltd.).

Specific examples of the conductivity imparting material include, but are not limited to, conductive fillers such as carbon-based fillers, metal-based fillers, metal oxide-based fillers, and metal coating-based fillers.

The metal-based fillers (e.g., Ag, Ni, Cu, Zn, Al, and Stainless) exhibit the highest conductivity and are unsuitable when aiming for high resistance. In addition, the metal-based fillers other than expensive Au and Ag are susceptible to oxidization and have a problem of a changing resistance value.

The metal oxide-based fillers (e.g., SnO₂, In₂O₃, and ZnO) require blending in a range of 10% by mass to 50% by mass with respect to a total of resins to obtain conductivity. Thus, decline in mechanical properties of a polymer may occur. In addition, the metal oxide-based fillers are high cost materials and are unsuitable as the conductivity imparting material according to an embodiment of the present invention.

The carbon-based fillers are low cost and control of resistance range from middle to high is also possible.

Among the carbon-based fillers, preferably a conductive carbon black is the conductivity imparting material. By employing the low cost conductive carbon black, a low cost conductive resin belt is obtained. In addition, stable electrical resistance with little environment dependency is obtained.

The conductive carbon black includes classes of ketjen black, acetylene black, and oil furnace black. There is no restriction regarding the conductive carbon black and any of the above-described classes of conductive carbon black may be employed. However, ketjen black has a superior number of particles per unit weight, and a desired resistance value may he obtained with a small blending amount. Accordingly, decline in mechanical properties may be kept to a minimum.

It is preferable that the conductivity imparting material a mix of the conductive carbon black and a macromolecular conductive material.

As described above, blending a large amount of the conductive fillers degrades mechanical properties. Thus, it is preferable that a blending amount of the conductive fillers is 10% by mass or less with respect to a total of resins. However, depending upon a combination of a polymer material and a carbon black material, there are cases in which a blending amount of the carbon black material may exceed 10% by mass with respect to a total of resins due to trying to obtain an electric property.

It has been determined that by combining the conductive carbon black and the macromolecular conductive material as the conductive filters, decline in mechanical properties according to increase of a blending amount of the conductive fillers may be prevented.

Besides conductive fillers, an ion-based material is well known as a material that imparts conductivity. In a method of employing an ion conductive effect, decline in surface resistivity is observed. However, control of making volume resistivity low is difficult. When trying to make a low volume resistivity, a blending amount of a surfactant becomes large and there is a problem of the surfactant bleeding out on the surface of a belt.

By employing the mix of the conductive carbon black and the macromolecular conductive material, it is possible to reduce a blending amount of the conductive carbon black and decline in mechanical properties may be minimized. In addition, control of electrical properties is possible. High precision and stable high surface resistivity and volume resistivity are repeatedly obtained. Stable electrical resistance with little environment dependency is obtained.

The macromolecular conductive material according to an embodiment of the present invention may be, for example, a polyether-based block polymer such as a commercially available material called “Pelectron” from Sanyo Chemical Industries, Ltd. When the polyether-based block polymer is mixed in a resin and heated and mixed, a stripe shaped conductive circuit is formed inside by stretching at formation. However, the polyether-based block polymer is unsuited for adjustment to match a desired electrical resistance value, and fine adjustment is difficult. By combining the conductive carbon black, a blending amount of the conductive fillers is reduced and adjustment to a desired electrical resistance is possible.

It is preferable that the conductive carbon black is set in a range of from 1% by mass to 5% by mass with respect to a total of resins and the macromolecular conductive material is set in a range of from 1% by mass to 3% by mass with respect to the total of resins.

It is preferable that the conductivity imparting material is a carbon fiber nanotube having a fiber diameter in a range of from 10 nm to 200 nm and a fiber length in a range of from 0.5 μm to 15 μm.

With a blending amount of the carbon nanotubes of 5% by mass with respect to a total of resins, a desired resistance value is obtained and decline in mechanical properties is minimized. Accordingly, cracking or chipping of an end portion of a belt when the belt is operating may be prevented. Moreover, stable electrical resistance with little environment dependency is obtained.

Carbon nanotubes (hereinafter referred to as CNT) having a large aspect ratio obtain conductivity with a small addition amount, and dispersibility is also good. To obtain volume resistivity in the range from 10⁸ Ω·cm to 10¹¹ Ω·cm with CNT having a fiber diameter in the range from 10 nm to 200 nm and the fiber length in the range from 0.5 μm to 15 μm, a blending amount is 1% by mass to 3% by mass with respect to a total of resins. Significant reduction of the blending amount is obtained compared to a blending ratio of carbon black, and good mechanical properties are attained.

The conductive resin belt according to an embodiment of the present invention may be manufactured by obtaining a melt-kneaded product by melting, mixing, and kneading at least one amorphous polymer selected from the first group, at least one crystalline polymer selected from the second group, at least one reactive polymer selected from the third group, and a conductivity imparting material; and obtaining a molded product by extrusion molding the melt-kneaded product.

Due to being able to obtain the molded product by extrusion molding, the conductive resin belt may be manufactured at a low cost. In addition, by molding the conductive resin belt after controlling a resistance value, viscoelasticity, and mechanical properties of the melt-kneaded product, the conductive resin belt of stable quality may be manufactured.

A method of manufacturing the conductive resin belt according to an embodiment of the present invention includes the obtaining the melt-kneaded product by melting, mixing, and kneading at least one amorphous polymer selected from the first group, at least one crystalline polymer selected from the second group, at least one reactive polymer selected from the third group, and a conductivity imparting material: and the obtaining the molded product by extrusion molding the melt-kneaded product.

Due to low cost manufacturing processes of the conductive resin belt, the conductive resin belt may be provided at a low cost. In addition, by molding the conductive resin belt after controlling a resistance value, viscoelasticity, and mechanical properties of the melt-kneaded product, the conductive resin belt of stable quality may be manufactured.

In the obtaining of the molded product by extrusion molding the melt-kneaded product, a mandrel 30 is provided at a downstream direction of extrusion of a die. It is preferable that cooling to a glass transition temperature or less of the melt-kneaded product is conducted at the mandrel 30. More specifically, a temperature of the mandrel 30 is preferably around 5° C. to 10° C. lower than the glass transition temperature of the melt-kneaded product.

FIG. 6 is a schematic view of an example of the die employed for extrusion molding. The mandrel 30 is provided at the downstream direction of extrusion of the die (e.g., spiral die 20) and directly connected to the die. The mandrel 30 is connected to an oil temperature adjustment device and temperature control is possible. A temperature of the mandrel 30 is set to a glass transition temperature or less of a melt-kneaded product. By the time the melt-knead product passes the mandrel 30, the melt-kneaded product is solidified. Accordingly, a molded product having a dimension of circumferential length that is the same as a mandrel diameter 31 is obtained. When the temperature of the mandrel 30 exceeds the glass transition temperature, the dimension of circumferential length of the melt-kneaded product may become smaller than the mandrel diameter 31 due to a draw out tension and may be unstable. In addition, a surface shape of the mandrel 30 may not be transferred and a film thickness may be non-uniform due to solidification of the melt-kneaded product occurring after the melt-kneaded product passes the mandrel 30. When the film thickness is non-uniform, mechanical strength or electrical resistance also becomes non-uniform at areas having different thickness.

Preferably, the thickness of the conductive resin belt according to an embodiment of the present invention is approximately 70 μm to approximately 90 μm.

A gloss level of the conductive resin belt correlates to a cooling speed from a melt state to a solid state of the conductive resin belt immediately after exiting from the die. Thus, a high temperature of the mandrel 30 is advantageous for gloss. When stretching occurs due to the draw out tension, gloss declines and thus it is preferable that the conductive resin belt is solidified by the time the conductive resin belt passes the mandrel 30. Preferably, a relation of a die lip diameter 21 and the mandrel diameter 31 is a one-to-one correspondence.

However, the mandrel diameter 31 may be controlled to approximately ±10% of the die lip diameter 21.

As described above, in the obtaining of the molded product by extrusion molding the melt-kneaded product, the mandrel 30 is provided at the downstream direction of extrusion of the die. By cooling the melt-kneaded product to the glass transition temperature or less of the melt-kneaded product at the mandrel 30, the conductive resin belt having the dimension of circumferential length may be manufactured. Due to being able to control uniform film thickness, manufacture of the conductive resin belt with a quality of having stable mechanical strength is possible. Accordingly, the conductive resin belt having a uniform electrical resistance may be manufactured. In addition, control of the gloss level is possible and the conductive resin belt having good surface gloss may be manufactured.

The conductive resin belt according to an embodiment of the present invention may be used as an intermediate transfer belt employed in an image forming apparatus including at least an electrostatic latent image forming mechanism to form an electrostatic latent image on an image carrier, a developing mechanism to develop the electrostatic latent image formed on the image carrier into a toner image employing a toner, a primary transfer mechanism to transfer the toner image on the image carrier to the intermediate transfer belt, a secondary transfer mechanism to transfer the toner image on the intermediate transfer belt to a recording sheet, and a fixing mechanism to fix the toner image on the recording sheet to the recording sheet.

An image forming apparatus according to an embodiment of the present invention includes at least an electrostatic latent image forming mechanism to form an electrostatic latent image on an image carrier, a developing mechanism to develop the electrostatic latent image formed on the image carrier into a toner image employing a toner, a primary transfer mechanism to transfer the toner image on the image carrier to an intermediate transfer belt, a secondary transfer mechanism to transfer the toner image on the intermediate transfer belt to a recording sheet, and a fixing mechanism to fix the toner image on the recording sheet to the recording sheet. The image forming apparatus according to an embodiment of the present invention employs the conductive resin belt according to an embodiment of the present invention as the intermediate transfer belt.

The conductive resin belt according to an embodiment of the present invention has good mechanical, electrical, and flame retardant requirements. By employing the conductive resin belt according to an embodiment of the present invention as the intermediate transfer belt, generation of cracking at end portions of the intermediate transfer belt when the intermediate transfer belt is operating may be prevented, and problems of image defects such as color registration misalignment may be overcome. The intermediate transfer belt obtains high elasticity and thus a durability of 200,000 sheets or more is obtained.

In the following, an exemplary embodiment of the present invention is described in detail with reference to the drawings.

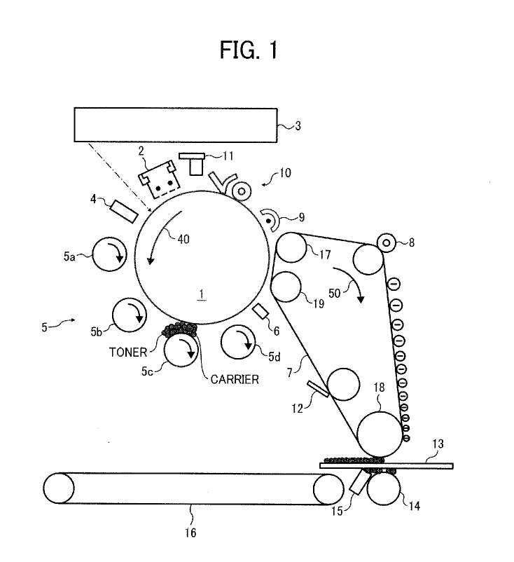

FIG. 1 is a schematic view of an example of a configuration of a full-color image forming apparatus employing the intermediate transfer method.

It is to be noted that FIG. 1 shows only the configuration of an image forming unit printer unit) of the full-color image forming apparatus. In a case in which the full-color image forming apparatus is a copier, the full-color image forming apparatus is provided with a publicly known image reading device (i.e., scanner unit).

The following is a description with respect to a full color copier as the example. A color image information of a document such as each color separation of red (hereinafter referred to as R), green (hereinafter referred to as G), and blue (hereinafter referred to as B) is read by an image reading device and converted into an electronic image signal.

Depending on the strength of the electronic image signals of each color separation of R, G, and B, a color conversion process is conducted at an image processing unit of the image reading device and conversion to color image data of cyan (C), magenta (M), yellow (Y), and black (K) is conducted.

Then, based upon the color image data, image formation is conducted employing toner of four colors, cyan (C), magenta (M), yellow (Y), and black (K), at the printer unit having the configuration shown in FIG. 1.

When employing the full color copier as a printer for a computer or a word processor, color image data is transmitted to the printer unit.

Next is a description of a configuration and an image forming action of the printer unit shown in FIG. 1.

An optical writing unit 3 in FIG. 1 converts color image data from an image reading device to an optical signal and conducts optical writing of an image corresponding to an original image.

The optical writing unit 3 may be, for example, an optical scanning device that forms an electrostatic latent image on a photoreceptor drum 1 by deflecting and scanning a laser beam emitted from a laser light source with a rotary polygon mirror and guiding a scanning light to the photoreceptor drum 1 via a constant velocity optical scanning system such as an fθ lens.

The optical writing unit 3 may also be an optical writing device employing an LED array or an optical writing device employing a liquid crystal shutter array.

The photoreceptor drum 1 serving as an image carrier rotates in a counterclockwise direction as shown by arrow 40 in FIG. 1. Devices to conduct electrophotographic image forming processes are provided around the photoreceptor drum 1 such as a charger 2, a potential sensor 4, a developing unit 5, a pattern detector 6 (i.e., pattern sensor) to detect density of developed images, an endless belt shaped intermediate transfer body 7, a pre-cleaning neutralizing unit 9 (i.e., pre-cleaning charge eliminator, Pcc), a photoreceptor drum cleaning device 10 (e.g., cleaning brush, cleaning blade), and a neutralizing lamp 11.

The developing unit 5 includes a black developing member 5a, a cyan developing member 5b, a magenta developing member 5c, and a yellow developing member 5d. A developer of each developing member 5a, 5b, 5c, and 5d is a two component developer. Each of the two component developer is formed of a toner of a color of one of the developing members 5a, 5b, 5c, and 5d and a carrier. Only a developing sleeve of each developing member 5a, 5b, 5c, and 5d of the developing unit 5 is shown in FIG. 1. The whole of each developing member 5a, 5b, 5c, and 5d or other parts such as a developing paddle, or a toner supply member are omitted from FIG. 1.

When image forming processes are started, the charger 2 charges the photoreceptor drum 1 and optical writing is conducted by the optical writing unit 3 based on an image data of a first color such as black. Accordingly, an electrostatic latent image of the first color is formed.

Then, the electrostatic latent image of the first color is developed and made visible. In the above-described example in which the first color is black, the electrostatic latent image is developed at the black developing member 5a of the developing unit 5 and a black toner image is formed.

The black toner image formed on the photoreceptor drum 1 is transferred to a surface of the intermediate transfer body 7 at a contact portion between the photoreceptor drum 1 and the intermediate transfer body 7 driven at a constant velocity.

It is to be noted that the above-described transfer of the black toner image formed on the photoreceptor drum 1 to the surface of the intermediate transfer body 7 is called a primary transfer.

After transfer, residue toner on the photoreceptor drum 1 is removed with the pre-cleaning neutralizing unit 9 and the photoreceptor drum cleaning device 10, and neutralization of the surface of the photoreceptor drum 1 is conducted with the neutralizing lamp 11.

In a case of forming a full color image, the above-described image forming processes are conducted for the next color after the First color of black. The above-described image forming processes of forming the electrostatic latent image, developing, and the primary transfer are sequentially repeated for other remaining second to fourth colors, cyan, magenta, and yellow. Accordingly, the full color image is formed on the intermediate transfer body 7.

It is to be noted that there are also cases in which a full color image is formed with only the three colors cyan, magenta, and yellow.

The intermediate transfer body 7 is formed of an endless belt shaped material and is stretched around a drive roller 18, a belt transfer bias roller 17, a transfer grounding roller 19, and a group of following rollers. A drive motor not shown in FIG. 1 rotates the intermediate transfer body 7 in the direction of an arrow 50 in FIG. 1. The above-described primary transfer of a toner image is conducted by applying a predetermined bias voltage to the belt transfer bias roller 17 when the photoreceptor drum 1 and the intermediate transfer body 7 is in a contact state.

Provided around the intermediate transfer body 7 are a sweeper brush 8, a transfer member 14 (e.g., sheet transfer bias roller) to transfer a toner image on the intermediate transfer body 7 to a transfer material 13, and a belt cleaning device 12 (e.g., cleaning blade, brush roller, etc.). The sweeper brush 8, the transfer member 14, and the belt cleaning device 12 include a contact and separation mechanism not shown in FIG. 1. When forming the full color image, the sweeper brush 8, the transfer member 14, and the belt cleaning device 12 are separated from the surface of the intermediate transfer body 7 while transfer of toner images of a first color to a fourth color (or toner images of a first color to a third color) to the intermediate transfer body 7 are being conducted.

After the full color image is formed on the intermediate transfer body 7 with the above-described processes, the transfer member 14 is contacted with the intermediate transfer body 7 by the contact and separation mechanism not shown in FIG. 1. Accordingly, the full color image that is a composite toner image of four colors is transferred to the transfer material 13 (i.e., recording sheet) at a contact portion. Transfer of the full color image on the surface of the intermediate transfer body 7 to the transfer material 13 is called a secondary transfer.

Then, the transfer material 13 having the full color image is separated from the intermediate transfer body 7 by a separating member 15. A conveying belt 16 conveys the transfer material 13 having the full color image to a publicly known fixing device not shown in FIG. 1. After a fixing process, the full color image is outputted.

After secondary transfer, the belt cleaning device 12 and the sweeper brush 8 is contacted with the intermediate transfer body 7 by the contact and separation mechanism not shown in FIG. 1 and the surface of the intermediate transfer body 7 is cleaned and neutralized.

### EXAMPLES

Further understanding can be obtained by reference to specific examples, which are provided hereinafter. However, it is to be understood that the embodiments of the present invention are not limited to the following examples.

### Examples 1 to 7 and Comparative Examples 1 to 4

Combination conditions of each of the examples and the comparative examples are shown in Table 2. Numerical values indicate parts by mass. Molding conditions and evaluation results are shown in Table 3. Specifically, combination materials of each example and comparative example are formed into a pellet by employing a twin screw extruding kneader (L/D=60). Then, each pellet is extrusion molded employing an annular shaped die shown in FIG. 6. Accordingly, a conductive resin belt of each example and comparative example having dimensions of an inner diameter of 250 mm and width of 240 mm is obtained.

TABLE 2

| | | | Ex. | Ex. | Ex. | Ex. | Ex. | Ex. | Ex. | Comp. | Comp. | Comp. | Comp. |
|---|---|---|---|---|---|---|---|---|---|---|---|---|---|
| | | | 1 | 2 | 3 | 4 | 5 | 6 | 7 | Ex. 1 | Ex. 2 | Ex. 3 | Ex. 4 |
| Blend | Amorphous | PEI/Ultem 1000 | 80 | 80 | 80 | 80 | — | — | 80 | 100 | — | 80 | — |
| (Parts | polymer | (*1) | | | | | | | | | | | |
| by | | PES/4100G (*2) | — | — | — | — | 80 | 80 | — | — | 100 | — | 80 |
| mass) | Crystalline | PPS/PY-23 (*3) | 20 | 20 | 20 | 20 | 20 | — | 20 | — | — | 20 | 20 |
| | polymer | PEEK/L4000G | — | — | — | — | — | 20 | — | — | — | — | — |
| | | (*4) | | | | | | | | | | | |
| | Reactive | Copolymer of | 1 | 1 | 1 | 1 | 1 | 1 | — | — | — | — | — |
| | polymer | ethylene and | | | | | | | | | | | |
| | | glycidyl | | | | | | | | | | | |
| | | methacrylate/ | | | | | | | | | | | |
| | | Bondfast E (*5) | | | | | | | | | | | |
| | | Polymer | — | — | — | — | — | — | 2 | — | — | — | — |
| | | including the | | | | | | | | | | | |
| | | oxazoline | | | | | | | | | | | |
| | | group/Epocros | | | | | | | | | | | |
| | | RPS-1005 (*6) | | | | | | | | | | | |
| | Conductivity | Denka black | — | — | 4.5 | — | — | — | — | — | — | — | — |
| | imparting | (*7) | | | | | | | | | | | |
| | material | Ketjen black | 8 | 2 | — | — | 8 | 8 | 8 | 8 | 8 | 8 | 8 |
| | | EC300J (*8) | | | | | | | | | | | |
| | | Pelectron P (*9) | — | 3 | 3 | — | — | — | — | — | — | — | — |
| | | CNT/NT-7 | — | — | — | 2.5 | — | — | — | — | — | — | — |
| | | (*10) | | | | | | | | | | | |

(Ex. = Example/Comp. Ex.= Comparative example)
(*1) PEI/Ultem 1000: SABIC Innovative Plastics Japan
(*2) PES/4100G: Sumitomo Chemical Co, Ltd.
(*3) PPS/PY-23: Linear type high molecular weight PPS Toray Industries, Inc.
(*4) PEEK/5000G: Daicel-Evonik Ltd.
(*5) Copolymer of ethylene and glycidyl methacrylate/Bondfast E: Sumitomo Chemical Co, Ltd.
(*6) Polymer including the oxazoline group/Epocros RPS-1005: Nippon Shokubai Co., Ltd.
(*7) Denka black: Denka Kagaku Kogyo Kabushiki Kaisha
(*8) Ketjen black EC300J: Lion Corporation
(*9) Pelectron P: Sanyo Chemical Industries, Ltd.
(*10) CNT/NT-7: Hodogaya Chemical Co. Ltd.

A cross-section of the obtained conductive resin belt of each example and comparative example is observed using TEM. The cross-section structure of examples 1 to 7, comparative example 3, and comparative example 4 are confirmed as including a dispersion phase and a continuous phase. In addition, the examples 1 to 7 are confirmed as including a reactive polymer present at a concentration of 30% to 70% within 10 nm to 1 μm of an interface between the dispersion phase and the continuous phase. A conductivity imparting material is confirmed to be eccentrically located in either the dispersion phase or the continuous phase.

Obtained conductive resin belts of each example and comparative example are evaluated according to the following steps.

### <Evaluation of Mechanical Properties>

Evaluation is conducted in accordance with each of the following standards.

Tensile strength (rupture point stress)/in compliance with JIS-K7127

Tensile elasticity/in compliance with JIS-K7127

Elongation at rupture point/in compliance with JIS-K7127

Flexibility resistance (MIT)/in compliance with JIS-P8115

Tear strength/in compliance with JIS-K7128

### <Evaluation of Flame Retardant Properties>

Evaluation is conducted in compliance with UL94 Standard

### <Evaluation of Electrical Resistance>

Surface resistivity and volume resistivity are measured under the following conditions.

Sample humidity control conditions: 20±3° C., Relative humidity: 50±10%, Humidity control for four hours

Measurement environment: 20±3° C., Relative humidity: 50±10%

Measurement device: Hiresta UP Model MCP-HT450 (from DIA Instruments Co., Ltd.), URS probe

Measurement voltage: 100V, 500V

Voltage application time: 10 sec value

### <Evaluation of Phase-Separated Structure and Dispersion State>

Phase-separated structure and dispersion state are measured under the following conditions.

Measurement device: FE-TEM JEM-2100F (from JEOL Ltd.)

Measurement conditions: Acceleration voltage 200 kV, Observation magnification 0.2 k to 8 k

The following evaluation is conducted with respect to obtained kneaded products of each example and comparative example.

### <Heat Evaluation>

Glass transition temperature of the obtained kneaded products is measured under the following conditions.

Measurement device: X-DSC7000 (from Shimadzu Corporation)

Measurement conditions: Rate of temperature increase 10° C./min, Measured temperature range 25° C. to 350° C.

TABLE 3

| | | Ex. | Ex. | Ex. | Ex. | Ex. | Ex. | Ex. | Comp. | Comp. | Comp. | Comp. |
|---|---|---|---|---|---|---|---|---|---|---|---|---|
| | | 1 | 2 | 3 | 4 | 5 | 6 | 7 | Ex. 1 | Ex. 2 | Ex. 3 | Ex. 4 |
| | Molding | 330 | 330 | 320 | 320 | 320 | 360 | 330 | 350 | 365 | 330 | 330 |
| | temperature | | | | | | | | | | | |
| | (° C.) | | | | | | | | | | | |
| | Molding | 80 | 85 | 83 | 85 | 83 | 77 | 80 | 79 | 83 | 82 | 84 |
| | thickness | | | | | | | | | | | |
| | (μm) | | | | | | | | | | | |
| | Mandrel | 210 | 210 | 185 | 185 | 185 | 210 | 210 | 210 | 220 | 210 | 210 |
| | temperature | | | | | | | | | | | |
| | (° C.) | | | | | | | | | | | |
| Evaluation | Glass | 221 | 220 | 220 | 220 | 214 | 215 | 220 | 220 | 215 | 220 | 215 |
| results | transition | | | | | | | | | | | |
| | temperature | | | | | | | | | | | |
| | (° C.) | | | | | | | | | | | |
| | Flame | VTM-0 | VTM-0 | VTM-0 | VTM-0 | VTM-0 | VTM-0 | VTM-0 | VTM-0 | VTM-0 | VTM-0 | VTM-0 |
| | retardant | | | | | | | | | | | |
| | properties | | | | | | | | | | | |
| | Tensile | 80 | 76 | 83 | 81 | 63 | 68 | 82 | 102 | 70 | 78 | 71 |
| | strength | | | | | | | | | | | |
| | (MPa) | | | | | | | | | | | |
| | Tensile | 1950 | 1910 | 2150 | 1930 | 2500 | 1850 | 1970 | 2200 | 2150 | 1980 | 2050 |
| | Elasticity | | | | | | | | | | | |
| | (MPa) | | | | | | | | | | | |
| | Elongation | 25 | 30 | 23 | 25 | 25 | 23 | 26 | 12 | 9 | 8 | 11 |
| | (%) | | | | | | | | | | | |
| | Flexibility | 620 | 580 | 560 | 600 | 550 | 650 | 650 | 180 | 110 | 600 | 320 |
| | resistance | | | | | | | | | | | |
| | MIT | | | | | | | | | | | |
| | (Number | | | | | | | | | | | |
| | of times) | | | | | | | | | | | |
| | Tear | 3.1 | 3.3 | 3.2 | 3.5 | 5.5 | 5.2 | 4.2 | 3.1 | 2.9 | 2.7 | 2.8 |
| | strength | | | | | | | | | | | |
| | (N/mm) | | | | | | | | | | | |
| | Surface | 10.8 | 10.6 | 10.7 | 11 | 10.9 | 11 | 10.5 | 10.5 | 10.8 | 10.7 | 10.9 |
| | resistivity | | | | | | | | | | | |
| | 100 V | | | | | | | | | | | |
| | LogRs | | | | | | | | | | | |
| | (Ω/sq) | | | | | | | | | | | |
| | Surface | 10.3 | 10.1 | 10.2 | 10.7 | 10.3 | 10.5 | 10 | 9.4 | 9.7 | 9.3 | 9.5 |
| | resistivity | | | | | | | | | | | |
| | 500 V | | | | | | | | | | | |
| | LogRs | | | | | | | | | | | |
| | (Ω/sq) | | | | | | | | | | | |
| | Volume | 10.2 | 10.3 | 10.5 | 10.6 | 10.5 | 10.6 | 10.2 | 10.6 | 10.2 | 10.3 | 10.5 |
| | resistivity | | | | | | | | | | | |
| | 100 V | | | | | | | | | | | |
| | LogRv | | | | | | | | | | | |
| | (Ω · cm) | | | | | | | | | | | |
| | Volume | 8.4 | 8.3 | 7.5 | 8.1 | 7.8 | 8.1 | 8.4 | 7.8 | 7.5 | 7.7 | 8.2 |
| | resistivity | | | | | | | | | | | |
| | 500 V | | | | | | | | | | | |
| | LogRv | | | | | | | | | | | |
| | (Ω · cm) | | | | | | | | | | | |
| | Cocentration | 66 | 58 | 63 | 71 | 54 | 47 | 32 | — | — | — | — |
| | (%) of | | | | | | | | | | | |
| | reactive | | | | | | | | | | | |
| | polymer | | | | | | | | | | | |
| | present at | | | | | | | | | | | |
| | interface | | | | | | | | | | | |
| | CB | PEI | PEI | PEI | PEI | PPS | PEEK | PEI | — | — | PEI | PPS |
| | eccentrically | | | | | | | | | | | |
| | located | | | | | | | | | | | |
| | polymer | | | | | | | | | | | |

Belt diameter: Ø 250

In view of the foregoing, the conductive resin belt according to an embodiment of the present invention satisfies the above-described mechanical, electrical, and flame retardant requirements and may be manufactured at low cost.

What is claimed is:

1. A conductive resin belt, comprising:
at least one amorphous polymer selected from a first group consisting of polyether imide and polyether sulfone;
at least one crystalline polymer selected from a second group consisting of polyether ether ketone and polyphenylene sulfide;
at least one reactive polymer selected from a third group consisting of a copolymer of ethylene and glycidyl methacrylate and a polymer including an oxazoline group; and
a conductivity imparting material,
wherein surface resistivity of the conductive resin belt at 500V is 10⁶ Ω/sq to 10¹⁴ Ω/sq, and volume resistivity of the conductive resin belt at 100V is 10⁶ Ω·cm to 10¹⁴ Ω·cm,
wherein a cross-section of the conductive resin belt includes a dispersion phase and a continuous phase, and
wherein the reactive polymer exists at a concentration of 30% to 70% within 10 nm to 1 μm of an interface between the dispersion phase and the continuous phase, with the conductivity imparting material eccentrically located at either the dispersion phase or the continuous phase.

2. The conductive resin belt of claim 1, wherein the conductivity imparting material is a conductive carbon black.

3. The conductive resin belt of claim 1, wherein the conductivity imparting material is a mix of conductive carbon black and a macromolecular conductivity material.

4. The conductive resin belt of claim 1, wherein the conductivity imparting material is a carbon fiber nanotube having a fiber diameter in a range of from 10 nm to 200 nm and a fiber length in a range of from 0.5 μm to 15 μm.

5. The conductive resin belt of claim 1, prepared by a process comprising the steps of:
obtaining a melt-kneaded product by melting, mixing, and kneading the amorphous polymer of at least one of polyether imide and polyether sulfone, the crystalline polymer of at least one of polyether ether ketone and polyphenylene sulfide, the reactive polymer of at least one of the copolymer of ethylene and glycidyl methacrylate and the polymer including the oxazoline group, and the conductivity imparting material; and
obtaining a molded product by extrusion molding the melt-kneaded product.

6. A method of manufacturing the conductive resin belt of claim 1, comprising the steps of:
obtaining the melt-kneaded product by melting, mixing, and kneading the amorphous polymer of at least one of polyether imide and polyether sulfone, the crystalline polymer of at least one of polyether ether ketone and polyphenylene sulfide, the reactive polymer of at least one of the copolymer of ethylene and glycidyl methacrylate and the polymer including the oxazoline group, and the conductivity imparting material; and
obtaining the molded product by extrusion molding the melt-kneaded product.

7. The method of manufacturing the conductive resin belt of claim 6, wherein the step of obtaining the molded product by extrusion molding the melt-kneaded product comprises:
providing a die and a mandrel provided at a downstream direction of extrusion molding of the die; and
cooling the melt-kneaded product to a glass transition temperature or less of the melt-kneaded product at the mandrel.

8. The conductive resin belt of claim 1, wherein the conductive resin belt is used as an intermediate transfer belt employed in an image forming apparatus, the image forming apparatus comprising:
an electrostatic latent image forming mechanism to form an electrostatic latent image on an image carrier;
a developing mechanism to develop the electrostatic latent image formed on the image carrier into a toner image employing a toner;
a primary transfer mechanism to transfer the toner image on the image carrier to the intermediate transfer belt;
a secondary transfer mechanism to transfer the toner image on the intermediate transfer belt to a recording sheet; and
a fixing mechanism to fix the toner image on the recording sheet to the recording sheet.

9. An image apparatus employing the conductive resin belt of claim 1 as an intermediate transfer belt, the image forming apparatus comprising:
an electrostatic latent image forming mechanism to form an electrostatic latent image on an image carrier;
a developing mechanism to develop the electrostatic latent image formed on the image carrier into a toner image employing a toner;
a primary transfer mechanism to transfer the toner image on the image carrier to the intermediate transfer belt;
a secondary transfer mechanism to transfer the toner image on the intermediate transfer belt to a recording sheet; and
a fixing mechanism to fix the toner image on the recording sheet to the recording sheet.
